(19) United States
(12) Patent Application Publication
(10) Pub. No.: US 2005/0110612 A1
(43) Pub. Date: May 26, 2005

(54) Communication device with RFID functions

(75) Inventor: Curtis Lee Carrender, Morgan Hill, CA (US)

Correspondence Address: SEED INTELLECTUAL PROPERTY LAW GROUP PLLC, 701 FIFTH AVENUE, SUITE 6300, SEATTLE, WA, 98104-7092, US

(73) Assignee: Battelle Memorial Institute, Richland, WA (US)

(21) Appl. No.: 10/721,054

(22) Filed: Nov. 24, 2003

(51) Int. Cl. H04Q 5/22

(52) U.S. Cl. 340/10.1

(57) ABSTRACT

A communication device having radio frequency identification capabilities including an adapter of existing transmission and reception circuitry for transmitting an interrogation signal and receiving a backscatter modulated return signal. The device can be further modified to retransmit the backscatter modulated return signal, display the same to a user through an interface, or process the same in the device, or a combination of the foregoing. A communication device is also provided having RFID and other communication capabilities and software drivers are utilized to control operation of the device in an RFID interrogation mode.

### BACKGROUND OF THE INVENTION

1. Field of the Invention

The present invention pertains to the adaptation and configuration of existing sources, such as modems, portable communication devices, cell phones, personal digital assistants, and the like, to communicate with electromagnetic transponders, particularly radio frequency identification devices.

2. Description of the Related Art

Electronic communication devices utilized in transmitting and receiving data and information in analog and digital form include cell phones, either analog, digital PCS, VOIP, or other protocol; modems, including 802.11 or other standard modems; short-range communication devices, such as those utilizing Bluetooth or other standard short-range communication protocol; personal digital assistants; and the like. While these devices have been configured for wireless communication, such communication is limited to certain applications and to specific frequencies.

In U.S. Pat. No. 6,507,279, a Complete Integrated Self-Checkout System and Method is disclosed wherein it is suggested that a personal digital assistant (PDA) device be configured to scan bar codes. In addition, the PDA is utilized for receiving information from a radio frequency identification interrogator. The PDA is not capable of communicating with or interrogating a radio frequency transponder device.

An Object Detection System is disclosed in U.S. Pat. No. 6,624,752, which utilizes a cell phone to receive active transmissions from a remote radio frequency identification transmitter. Here, a transmitter-based system sends signals from a luggage identification device that is received at the cell phone locating the luggage. However, the cell phone has no capability for interrogating the remote transmitter or for providing power to the remote transmitter.

### BRIEF SUMMARY OF THE INVENTION

In accordance with one embodiment of the invention, a portable communication device is provided. The device includes: means for transmitting electromagnetic signals; means for receiving electromagnetic signals; and means for adapting the transmitting means and the receiving means to transmit a radio frequency interrogation signal and to receive a backscatter modulated reflected signal.

In accordance with another embodiment of the invention, an enhanced portable telephone is provided that includes an antenna circuit configured to transmit and receive voice and data signals; a receiver circuit coupled to the antenna and configured to receive the voice and data signals; a transmitter circuit coupled to the antenna circuit and configured to transmit voice and data signals; means for adapting the transmitter circuit to transmit radio frequency interrogation signals; and means for adapting the receiver circuit to receive backscatter modulated reflected signals.

In accordance with another embodiment of the invention, an enhanced modem is provided that includes means for translating a modulated signal; means for receiving and demodulating a modulated signal; means for adapting the transmitting means to transmit a radio frequency interrogation signal; and means for adapting the receiver to receive backscatter modulated reflected signals responsive to the interrogation signals.

In accordance with another embodiment of the invention, a communication device with parasitic reader is provided that includes a transceiver circuit coupled to an antenna for transmitting and receiving signals, the transceiver circuit including a processing circuit; and means for adapting the processing circuit and to receive and process backscatter modulated reflected signals responsive to transmitted interrogation signals. Ideally, the adapting means includes means to control the transceiver circuit to generate radio frequency interrogation signals.

In accordance with another embodiment of the invention, an enhanced radio frequency transceiver is provided that a radio frequency transceiver circuit coupled to an antenna circuit for transmitting and receiving data signals; a voice transceiver circuit coupled to the antenna circuit for the transmission of radio frequency interrogation signals and for receiving backscatter modulated reflected signals responsive to the interrogation signals; and means for adapting the radio frequency transceiver circuit to transmit and receive voice signals and for generating audible sound responsive to the voice signals.

In accordance with another embodiment of the invention, an enhanced radio frequency transceiver is provided that a radio frequency transceiver circuit coupled to an antenna circuit for transmitting radio frequency interrogation signals and receiving backscatter modulated reflected signals responsive to the interrogation signals; and means for adapting the radio frequency transceiver circuit to process modulation-demodulation signals.

In accordance with another embodiment of the invention, a radio frequency identification system combined with existing source is provided that includes a source for transmitting electromagnetic signals; means for receiving electromagnetic signals; means for adapting the source and the receiving means to transmit a radio frequency interrogation signal and to receive a backscatter modulated reflected signal, respectively; and a radio frequency transponder configured to receive the interrogation signal and to reflect the backscatter modulated signal responsive to the interrogation signal.

### BRIEF DESCRIPTION OF THE SEVERAL VIEWS OF THE DRAWING(S)

The foregoing features and advantages of the present invention will become more readily appreciated as the same are better understood from the following detailed description when taken in conjunction with the accompanying drawings, wherein:

FIG. 1 illustrates in block form a basic radio frequency idenification system;

FIG. 2 is a block diagram of the transmitter portion of a typical cell phone or modem;

FIG. 3 is a block diagram of a typical radio frequency identification interrogator;

FIG. 4 is a block diagram of a parasitic reader formed in accordance with the present invention;

FIG. 5 is a block diagram of a cellular telephone configured to include radio frequency identification interrogator circuit capabilities; and

FIG. 6 is a block diagram of a radio frequency identification interrogator having in-line additive circuitry to provide dual radio frequency identification interrogator and modem capabilities.

### DETAILED DESCRIPTION OF THE INVENTION

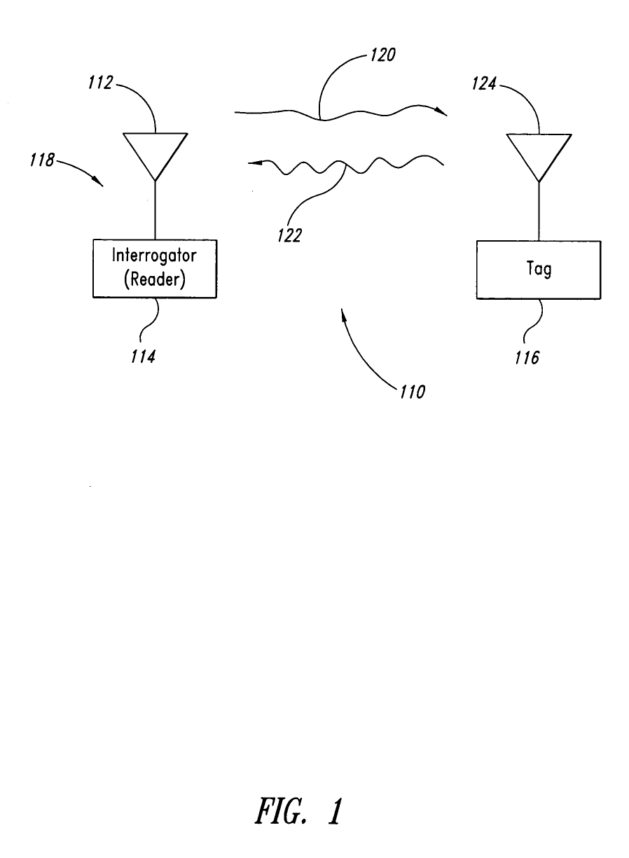

RF identification (RFID) tag systems have been developed to facilitate monitoring of remote objects. As shown in FIG. 1, a basic RFID system 110 consists of three components, an antenna 112 or coil, a transceiver with decoder 114, and a transponder (commonly called an RF tag) 116. In operation, the antenna 112 emits electromagnetic radio signals generated by the transceiver 114 to activate the tag 116. When the tag 116 is activated, data can be read from or written to the tag.

In some applications, the antenna 112 is a component of the transceiver and decoder 114 to become an interrogator (or reader) 118, which can be configured either as a hand held or a fixed-mount device. The interrogator 118 emits the radio signals 120 in range from one inch to one hundred feet or more, depending upon its power output and the radio frequency used. When an RF tag 116 passes through the electromagnetic radio signal waves 120, or the radio signal waves 120 reach the tag 116, the signal 120 is received by the tag 116, thereby activating the tag 116. Data encoded in the tag 116 is then reflected via by a data signal 122 through an antenna 124 to the interrogator 118 for subsequent processing.

An advantage of RFID systems is the non-contact, nonline-of-sight capability of the technology. Tags can be read through a variety of substances such as snow, fog, ice, paint, dirt, and other visually and environmentally challenging conditions where bar codes or other optically-read technologies would be useless. RF tags can also be read at remarkable speeds, in most cases responding in less than one hundred milliseconds.

There are three main categories of RFID tags. These are beam-powered passive tags, battery-powered semi-passive tags, and active tags. Each operate in fundamentally different ways.

The beam-powered RFID tag is often referred to as a passive device because it derives the energy needed for its operation from the radio frequency energy beamed at it. The tag rectifies the field and changes the reflective characteristics of the tag itself, creating a change in reflectivity that is seen at the interrogator. A battery-powered semi-passive RFID tag operates in a similar fashion, modulating its RF cross section in order to reflect a delta to the interrogator to develop a communication link. Here, the battery is the source of the tag's operational power. Finally, in the active RFID tag, a transmitter is used to create its own radio frequency energy powered by the battery.

A typical RF tag system 110 will contain at least one tag 116 and one interrogator 118. The range of communication for such tags varies according to the transmission power of the interrogator 118 and the tag 116. Battery-powered tags operating at 2,450 MHz have traditionally been limited to less than ten meters in range. However, devices with sufficient power can reach up to 200 meters in range, depending on the frequency and environmental characteristics.

Conventional RF tag systems utilize continuous wave backscatter to communicate data from the tag 116 to the interrogator 118. More specifically, the interrogator 118 transmits a continuous-wave radio signal to the tag 116, which modulates the signal 120 using modulated backscattering wherein the electrical characteristics of the antenna 120 are altered by a modulating signal from the tag that reflects a modulated signal 122 back to the interrogator 118. The modulated signal 122 is encoded with information from the tag 116. The interrogator 118 then demodulates the modulated signal 122 and decodes the information.

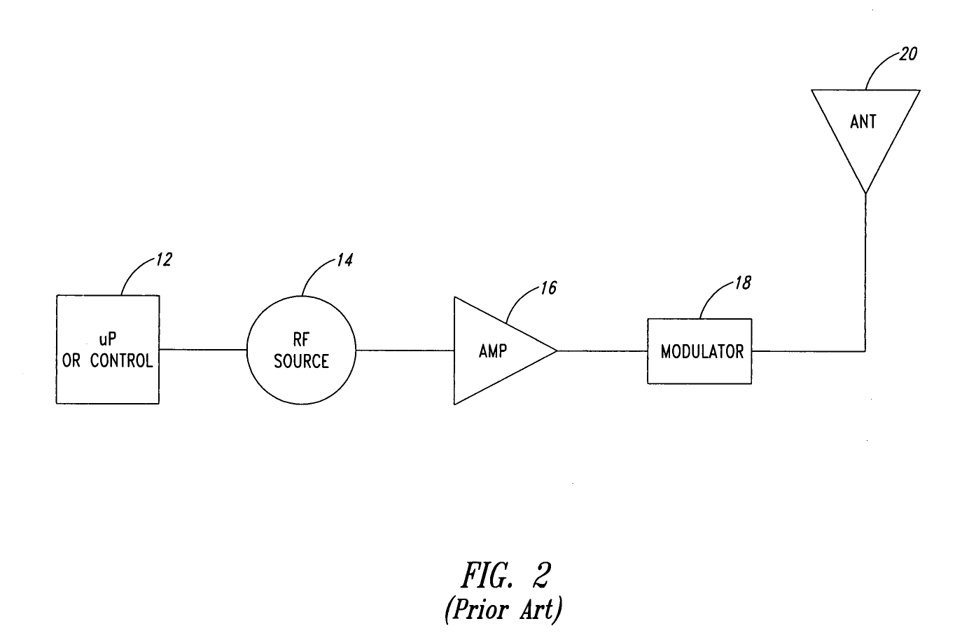

FIG. 2 is a block diagram illustrating the transmit portion of a standard modem or cell phone. Although modems and cell phones can be designed in a wide variety of configurations, the basic building blocks illustrated in FIG. 1 often exist. More particularly, the transmitter portion 10 generally includes a microprocessor or control unit 12 coupled to a radio frequency energy source, often in the 868 MHz to 2450 MHz band. The source of the radio frequency energy is sometimes a phase locked loop (PLL) or “transmitter” where the radio frequency energy is generated. The output of the RF source 14 is amplified to a higher state at an amplifier 16, the output of which is modulated at a modulator 18 to encode the RF signal with data. The antenna 20 is utilized to radiate the encoder or modulated RF signal.

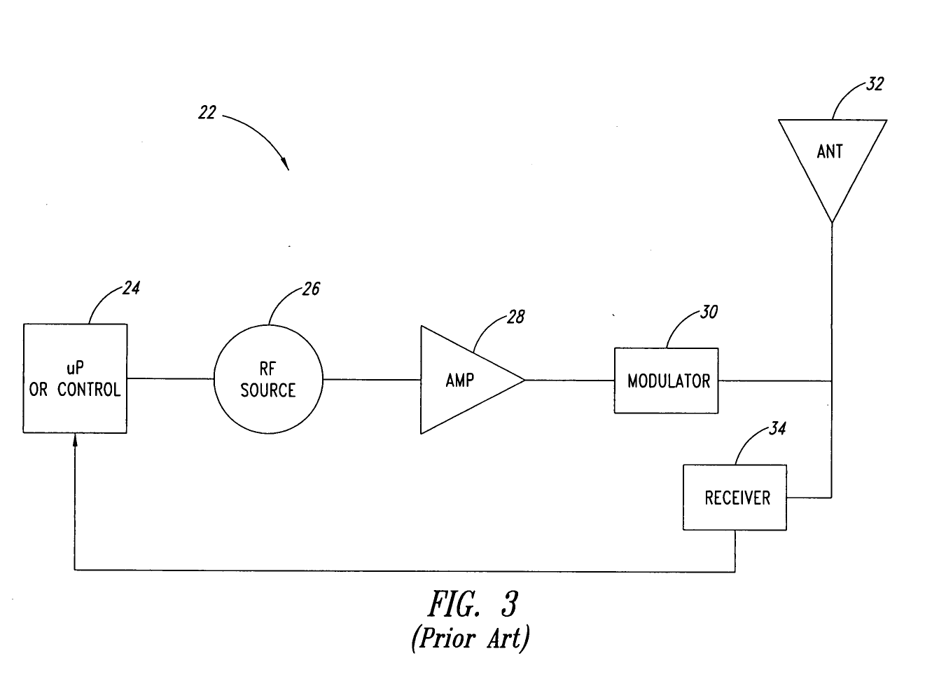

Similarly, FIG. 3 illustrates in block diagram format a typical radio frequency identification (RFID) reader or interrogator 22, which can likewise be designed in a wide variety of configurations but often includes the basic building blocks illustrated therein. These include the microprocessor or control circuit 24, the source of RF energy 26, the output of which is amplified via the amplifier 28. The amplified radio frequency signal is then encoded with data at the modulator 30 for transmission via the antenna 32. A receiver circuit 34 is coupled to the antenna 32 to receive the backscatter modulated signals from external transponder devices, such as RFID tags. The received signals are sent to the microprocessor or control circuit 24 for processing. The receiver 34 does not need to be in line with the rest of the system, but may be coupled in parallel between the antenna and the control circuit 24 as shown in FIG. 3.

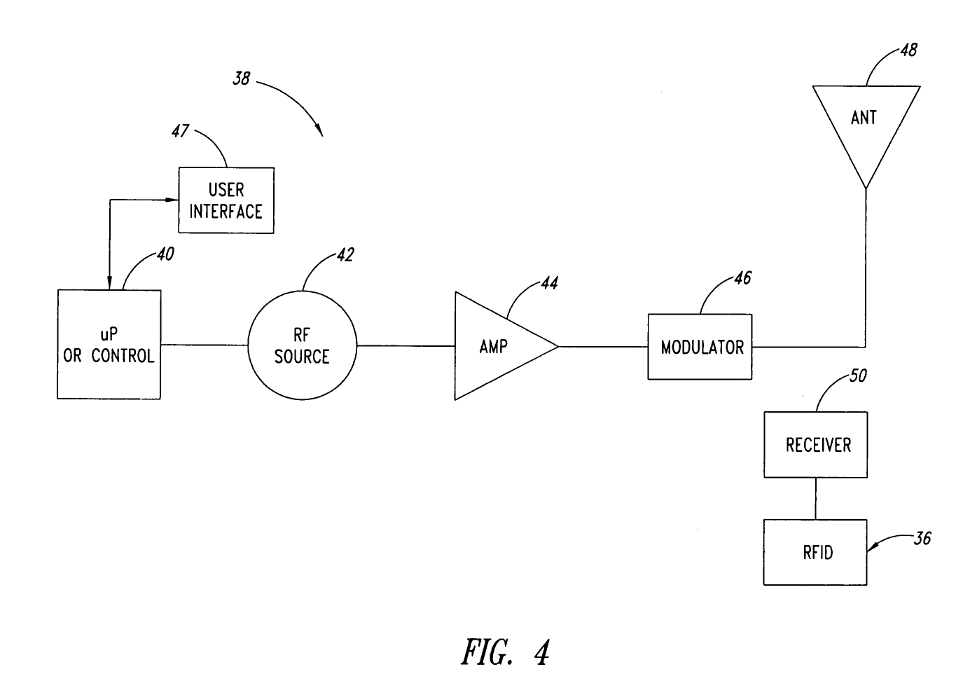

FIG. 4 illustrates one embodiment of the invention in the form of a parasitic RFID interrogator circuit 36 coupled to a communication circuit 38. As described above with respect to FIG. 2, this particular communication circuit includes the microprocessor or control circuit 40 coupled to the source of radio frequency energy 42. The radio frequency energy is amplified via the amplifier 44 and then encoded with data at the modulator 46 for transmission via the antenna 48. A receiver 50 is shown in association with the communication circuit 38. It is to be understood that the receiver 50 may be coupled in parallel between the antenna 48 and the control circuit 40 or coupled in line with the RF source 42, amplifier 44, and modulator 46, as is known in the art. Thus, the communications device 38 illustrated in FIG. 3 is intended to depict a modem or cell phone circuit to include the receiver 50 in either configuration. The source preferably generates signals in the frequency range of 800 to 2500 MHz, although a more narrow range may be used for specific applications.

Preferably, the RFID tags are passive devices that utilize the energy of the interrogation signal to modulate the interrogation signal for backscatter reflection to the interrogator circuit 36 and communication circuit 38.

The RFID interrogator circuit 36 is coupled to the existing receiver circuit 50 and hence to the antenna 48 and the control circuit 40 for transmission and reception of radio frequency identification signals. More particularly, the RFID interrogator circuit 36 utilizes the antenna 48 to transmit interrogation signals and to receive backscatter modulated signals from responding RFID tags. In one embodiment, the responsive signals are passed to the microprocessor or control circuit 40 for processing. In another embodiment, the received signals from the RFID tags can be transmitted to yet another device for processing utilizing the communication circuit 38. The received signals from the RFID tags can also be processed for display or otherwise communicated to a user through an interface 47, such as a visual display or generation of audible sound. This can be done through an existing LCD display screen or speaker associated with the communication circuit 38.

The RFID interrogator 36 enables the communication circuit 38 to function as a short range interrogator or reader. Utilizing the already-existing components in the communication circuit 38, the RFID interrogator can be implemented with inexpensive components. RFID capabilities can be provided in existing devices, such as cell phones, portable computers, PDAs, and the like by using a simple plug-in module adapted to function with the existing communication circuit 38.

Although the RFID interrogator 36 is of low cost and may have minimal capabilities, it does enable consumers to utilize their existing communication devices for a variety of tasks, such as determining costs of items in stores, locating tagged items, such as a tool in a garage, and the like. It also permits the user to not only observe the data resulting from the RFID communication, but to transmit it to another location for further processing, storage and later retrieval. This device also enables consumers to check the expiration date on products without having to remove the product from the shelf or freezer when shopping and keep a running total of items selected for purchase prior to check out.

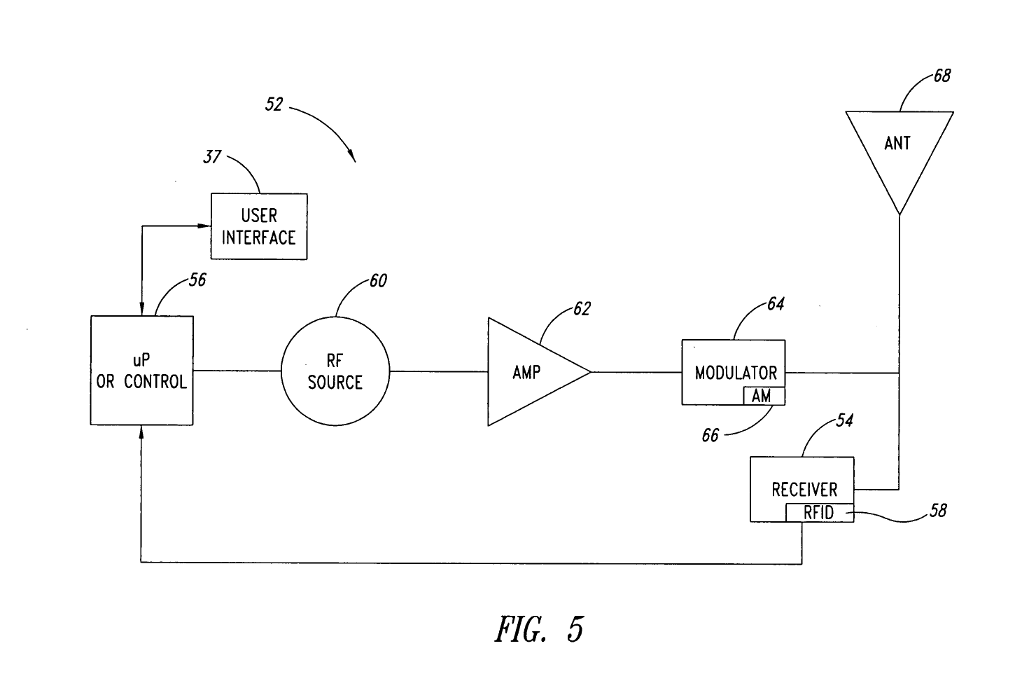

Illustrated in FIG. 5 is an implementation of the invention in a cell phone 52 wherein a receiver 54 coupled to a microprocessor or control circuit 56 is modified with RFID components 58 to have RFID interrogation capabilities. In this example, the radio frequency signal generated by the RF source 60 and enhanced by the amplifier 62 is now modulated at the modulator 64 that has been modified to have amplitude modulation capabilities. The necessary modification will vary by type of cell phone; however, amplitude modulation components 66 are added to the modulator 64 in a manner known to those skilled in the art with readily-commercially available components. Interrogation and cell phone communication signals are transmitted via the antenna 68, and the antenna 68 is capable of receiving backscatter modulated signals from remote transponders or RFID tags that are processed through the RFID receiver components 58. As described above, the user has the capability of reading RFID tags through an associated display or user interface.

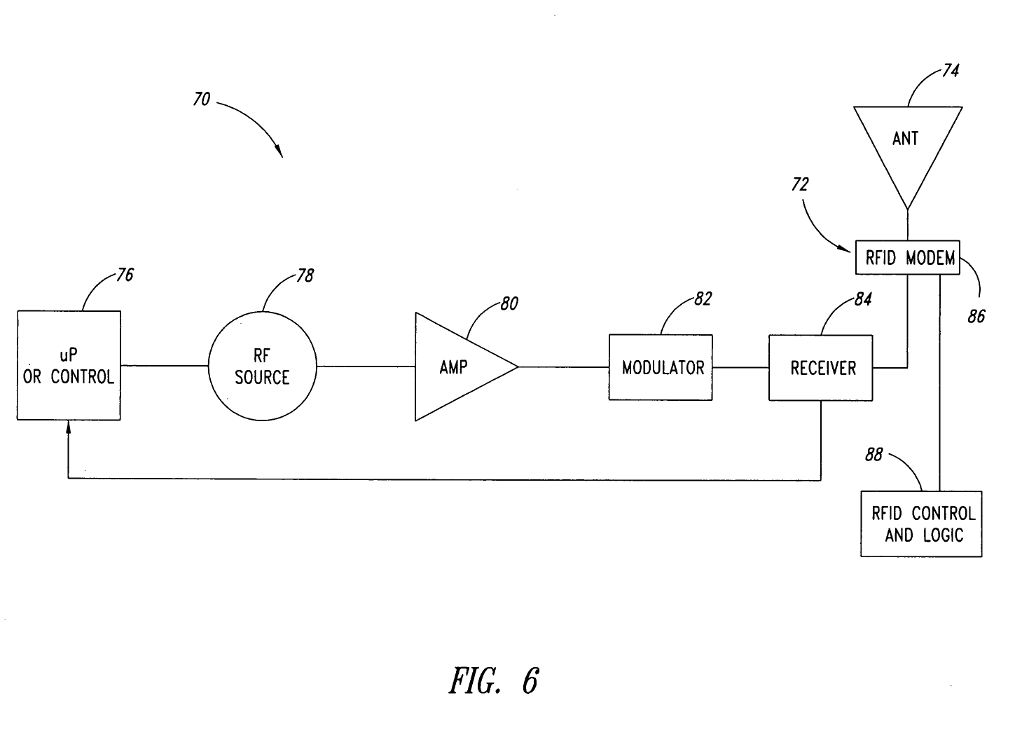

In another embodiment depicted in FIG. 6, a combination communication device and reader 70 is shown having in-line additive circuitry in the form of an RFID engine 72 coupled in line between an antenna 74 and a microprocessor or control circuit 76. The device includes the other components described in previous embodiments, including the source of radio frequency energy 78 coupled to the control circuit 76, the amplifier 80 for enhancing the radio frequency energy signals generated by the source 78, and the modulator circuit 82 for encoding data onto the enhanced RF signal. The existing receiver circuit 84 is shown coupled to the antenna 74 through the RFID engine 72 and also coupled to the control circuit 76.

The RFID engine 72 includes an RFID modem 86 coupled between the receiver 84 and the antenna 74 and an RFID control and logic circuit 88. Hence, the existing device, whether it be an existing blue tooth device, cell phone, or 802.11 modem, is now made RFID capable, avoiding the expense of utilizing a costly reader. It is contemplated that future portable communication devices will be manufacturer with RFID components that can be activated or deactivated utilizing software drivers. In addition, the present invention can be applied to existing devices in the form of software where the hardware may be existent but not activated or otherwise adapted to utilize RFID communications.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A portable communication device, comprising:
means for transmitting electromagnetic signals;
means for receiving electromagnetic signals; and
means for adapting the transmitting means and the receiving means to transmit a radio frequency interrogation signal and to receive a backscatter modulated reflected signal.

2. The device of claim 1, further comprising means for utilizing the backscatter modulated reflected signal.

3. The device of claim 2, further comprising an antenna circuit coupled to the transmitting means, the receiving means, and the adapting means.

4. The device of claim 3, wherein the transmitting means comprises a radio frequency source, an amplifier, and a modulator, the transmitting means further comprising a control circuit coupled to the radio frequency source and to the receiving means.

5. The device of claim 4, wherein the adapting means comprises means for adapting the modulator to have amplitude modulation capabilities.

6. The device of claim 5, wherein the adapting means comprises means for adapting the receiver to receive the backscatter modulated reflected signal.

7. An enhanced portable telephone, comprising:
an antenna circuit configured to transmit and receive voice and data signals;
a receiver circuit coupled to the antenna and configured to receive the voice and data signals;
a transmitter circuit coupled to the antenna circuit and configured to transmit voice and data signals;
means for adapting the transmitter circuit to transmit radio frequency interrogation signals; and
means for adapting the receiver circuit to receive backscatter modulated reflected signals.

8. The enhanced portable telephone of claim 7, further comprising means for utilizing the backscatter modulated reflected signal.

9. The enhanced portable telephone of claim 8, wherein the transmitter circuit comprises a modulator circuit, and wherein the means for adapting the transmitter comprises means for adapting the modulator circuit to have amplitude modulation capability.

10. An enhanced modem, comprising:
means for translating a modulated signal;
means for receiving and demodulating a modulated signal;
means for adapting the transmitting means to transmit a radio frequency interrogation signal; and
means for adapting the receiver to receive backscatter modulated reflected signals responsive to the interrogation signals.

11. The enhanced modem of claim 10, further comprising means for processing the backscatter modulated reflected signal.

12. The enhanced modem of claim 11, wherein the transmitting means comprises a modulator and the means for adapting the transmitting means comprises means for adapting the modulator to have amplitude modulation capabilities for generating the interrogation signal.

13. The enhanced modem of claim 12, wherein the receiving means is coupled to a processing circuit, and the means for adapting the receiving means comprises means for programming the processing circuit to receive and process the backscatter modulated reflected signals.

14. A communication device with parasitic reader, comprising:
a transceiver circuit coupled to an antenna for transmitting and receiving signals, the transceiver circuit including a processing circuit; and
means for adapting the processing circuit to control the transceiver circuit to generate radio frequency interrogation signals and to receive and process backscatter modulated reflected signals responsive to the transmitted interrogation signals.

15. The device of claim 14, wherein the adapting means comprises software programming stored in the processing circuit.

16. An enhanced radio frequency transceiver, comprising:
a radio frequency transceiver circuit coupled to an antenna circuit for transmitting and receiving data signals;
a voice transceiver circuit coupled to the antenna circuit for the transmission of radio frequency interrogation signals and for receiving backscatter modulated reflected signals responsive to the interrogation signals; and
means for adapting the radio frequency transceiver circuit to transmit and receive voice signals and for generating audible sound responsive to the voice signals.

17. The enhanced radio frequency transceiver of claim 16, further comprising means for visually displaying received data signals.

18. An enhanced radio frequency transceiver, comprising:
a radio frequency transceiver circuit coupled to an antenna circuit for transmitting radio frequency interrogation signals and receiving backscatter modulated reflected signals responsive to the interrogation signals; and
means for adapting the radio frequency transceiver circuit to process modulation-demodulation signals.

19. The enhanced radio frequency transceiver of claim 18, wherein the adapting means comprising 802.11-standard communication protocol.

20. A radio frequency identification system combined with existing source, comprising:
a source for generating and transmitting electromagnetic signals;
means for receiving electromagnetic signals;
means for adapting the transmitting means and the receiving means to transmit a radio frequency interrogation signal and to receive a backscatter modulated reflected signal; and
a radio frequency transponder configured to receive the interrogation signal and to reflect the backscatter modulated signal responsive to the interrogation signal.

21. The system of claim 20, further comprising means for processing the backscatter modulated reflected signal.

22. The device of claim 21, further comprising an antenna circuit coupled to the transmitting means, the receiving means, and the adapting means.

23. The system of claim 22, wherein the transmitting means comprises a radio frequency source, an amplifier, and a modulator, the transmitting means further comprising a control circuit coupled to the radio frequency source and to the receiving means.

24. The system of claim 23, wherein the adapting means comprises means for adapting the modulator to have amplitude modulation capabilities.

25. The system of claim 24, wherein the adapting means comprises means for adapting the receiver to receive the backscatter modulated reflected signal.
